(19) United States
(12) Patent Application Publication
(10) Pub. No.: US 2015/0131843 A1
(43) Pub. Date: May 14, 2015

(54) Support Base and Charger of Hand-Held Electronic Apparatus

(71) Applicant: LINKTEL INC., Taipei (TW)

(72) Inventors: Hong-Lin Lee, Taipei (TW); Wen-Hsiung Tsai, Taipei (TW); Tzi-I Yang, Taipei (TW)

(73) Assignee: LINKTEL INC., Taipei (TW)

(21) Appl. No.: 14/151,864

(22) Filed: Jan. 10, 2014

(30) Foreign Application Priority Data
Nov. 8, 2013 (TW) 102220931

(51) Int. Cl. H04R 1/02

(52) U.S. Cl. CPC H04R 1/02; H04R 2499/11
USPC 381/388

(57) ABSTRACT

A support base of a hand-held electronic apparatus configured for placing a hand-held electronic apparatus having a speaker is provided. The support base comprises an accommodating body which is formed with a hollow casing, and the shape of the accommodating body corresponds to a portion of the hand-held electronic apparatus such that the hand-held electronic apparatus can be placed therein. The characteristics of the present invention are as follows: The accommodating body comprises a first sound broadcasting hole and a second sound broadcasting hole, and when the hand-held electronic apparatus is placed in the accommodating body, the speaker of the hand-held electronic apparatus corresponds to the first sound broadcasting hole such that the speaker of the hand-held electronic apparatus can broadcast sound through the second sound broadcasting hole.

### FIELD OF THE INVENTION

The exemplary embodiments of the present invention relate to a support base and a charger. More specifically, the exemplary embodiments of the present invention relate to a support base and a charger of a hand-held electronic apparatus.

### BACKGROUND

With advances in hand-held electronic apparatus technology, related products are provided. Traditionally, if the user wants to broadcast the sound generated by the hand-held electronic apparatus, it is necessary to use a specific broadcasting apparatus. The hand-held electronic apparatus is placed on the broadcasting apparatus and connected to the broadcasting apparatus electrically, and then the speaker of the broadcasting apparatus is used to broadcast the sound of the hand-held electronic apparatus.

However, the majority of hand-held electronic apparatuses have speakers; thus, there is no need to add extra speakers unless a better sound quality is desired. In addition, the sound quality of the broadcasting apparatus depends on the speaker level, and thus for the object of broadcasting sound, the hand-held electronic apparatus can have a sound broadcasting function.

The present invention is based on the sound broadcasting function of the hand-held electronic apparatus, and the present invention further provides a placing base configured for placing the hand-held electronic apparatus therein, negating the need to assemble a speaker to broadcast the sound generated by the hand-held electronic apparatus.

### SUMMARY

A main object of the present invention is to provide a support base having a sound broadcasting function; the support base allows the hand-held electronic apparatus to broadcast sound.

Another main object of the present invention is to provide a support base or charger which can charge the hand-held electronic apparatus while simultaneously allowing the hand-held electronic apparatus to broadcast sound.

In order to achieve the aforementioned objects, the present invention provides a support base of a hand-held electronic apparatus configured for placing a hand-held electronic apparatus having a speaker. The support base comprises an accommodating body which is formed with a hollow casing, and the shape of the accommodating body corresponds to a portion of the hand-held electronic apparatus such that the hand-held electronic apparatus can be placed therein. The accommodating body comprises a first sound broadcasting hole and a second sound broadcasting hole; when the hand-held electronic apparatus is placed in the accommodating body, the speaker of the hand-held electronic apparatus is located corresponding to the first sound broadcasting hole, and the speaker of the hand-held electronic apparatus can broadcast sound through the first and the second sound broadcasting holes.

The accommodating body comprises an accommodating surface and a plurality of non-accommodating surfaces. The accommodating surface is the surface contacting the hand-held electronic apparatus, the first sound broadcasting hole is located in the accommodating surface, and the second sound broadcasting hole is located in one of the non-accommodating surfaces. The second sound broadcasting hole is located in an external surface of the accommodating body, and the external surface is the non-accommodating surface. The first sound broadcasting hole is a plurality of holes or/and the second sound broadcasting hole is a plurality of holes.

The support base can further have a charging function, and thus the support base can be used as a charger. In the embodiment, the support base further comprises a charging contact portion and the hand-held electronic apparatus has a charging contact, and when the hand-held electronic apparatus is placed in the accommodating body, the charging contact of the hand-held electronic apparatus contacts the charging contact portion so as to charge the hand-held electronic apparatus.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a schematic diagram illustrating the support base of the hand-held electronic apparatus in accordance with the present invention.

FIG. 2 is a schematic diagram drawn from a different viewing angle from that in FIG. 1 illustrating the support base of the hand-held electronic apparatus in accordance with the present invention.

FIG. 3 is a perspective diagram illustrating a second embodiment in accordance with the present invention.

FIG. 4 is another perspective diagram drawn from a different viewing angle from that in FIG. 3.

### DETAILED DESCRIPTION

For facilitating understanding and clarifying the object, characteristics, and advantages of the present invention, the following specific embodiments and figures of the present invention are presented as a detailed description.

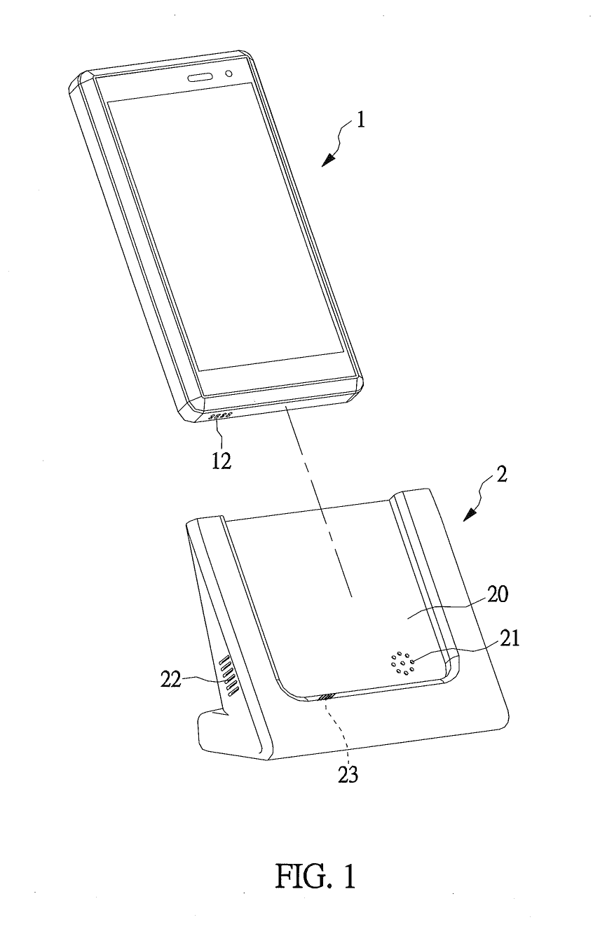

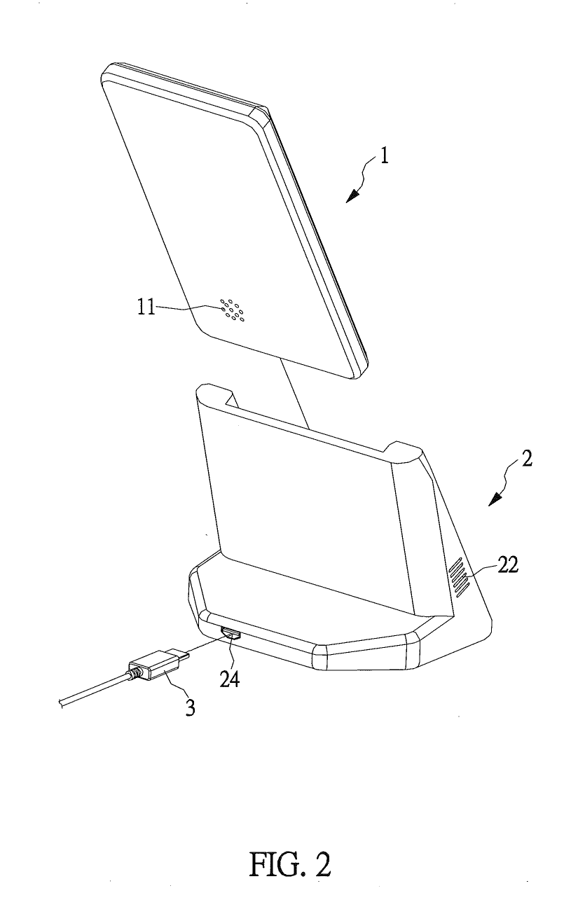

First please refer to FIG. 1 and FIG. 2 simultaneously; generally, the hand-held electronic apparatus 1 (such as cell phone or tablet) has a speaker 11 and charging contact 12 for being charged. The support base 2 provided by the present invention is configured for placing the hand-held electronic apparatus 1 therein.

The support base 2 comprises an accommodating body 20 formed with a hollow casing. The shape of the accommodating body 20 corresponds to a portion of the hand-held electronic apparatus 1 (for example the lower portion of the hand-held electronic apparatus 1) such that the hand-held electronic apparatus 1 can be placed therein. The accommodating body 20 comprises a first sound broadcasting hole 21 and a second sound broadcasting hole 22. When the hand-held electronic apparatus 1 is placed in the accommodating body 20, the speaker 11 of the hand-held electronic apparatus 1 is located corresponding to the first sound broadcasting hole 21. When the speaker 11 of the hand-held electronic apparatus 1 plays sound, then because the support base 2 is formed with a hollow casing, the sound broadcasted by the speaker 11 of the hand-held electronic apparatus 1 can be sent out through the second sound broadcasting hole 22. The support base 2 does not need an extra electronic device such as a speaker but uses the air space of the hollow casing to transmit the sound to achieve the sound broadcasting effect. It is preferred that the first sound broadcasting hole 21 is a plurality of holes or/and the second sound broadcasting hole 22 is a plurality of holes.

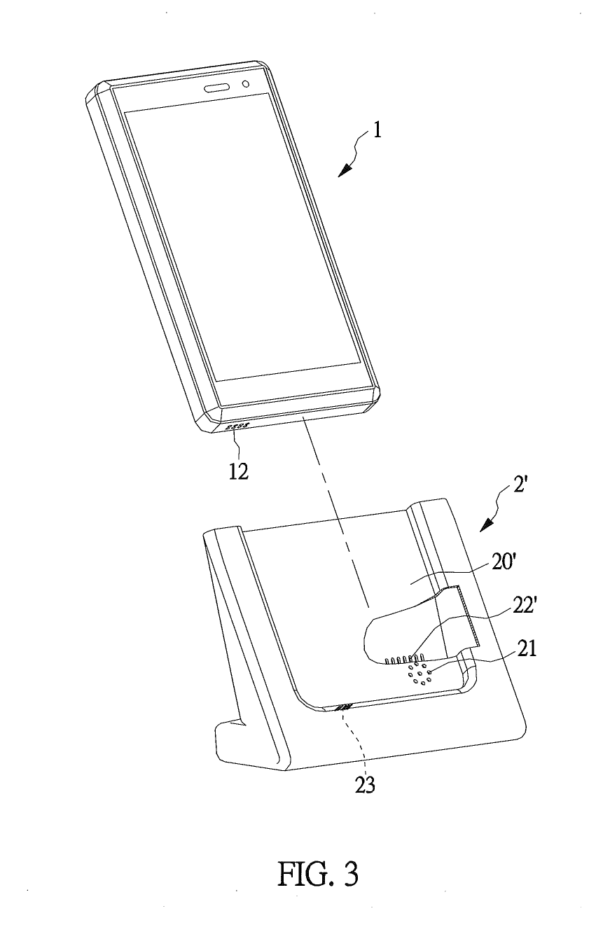

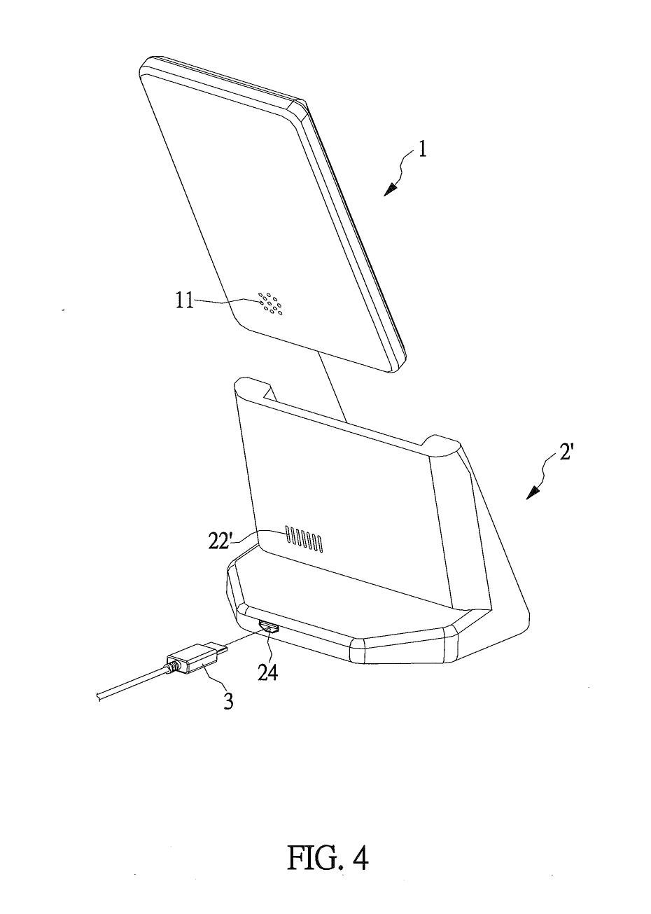

The accommodating body 20 comprises an accommodating surface and a plurality of non-accommodating surfaces. The accommodating surface is the surface contacting the hand-held electronic apparatus 1, and the non-accommodating surfaces do not contact the hand-held electronic apparatus 1. The first sound broadcasting hole 21 is located in the accommodating surface, and the second sound broadcasting hole 22 is located in any one of the non-accommodating surfaces; for example, the second sound broadcasting hole 22 is located in an external surface of the accommodating body 20. However, the present invention is not limited thereto. Please refer to FIG. 3 and FIG. 4 simultaneously; the second sound broadcasting hole 22′ can also be located in the rear surface of the non-accommodating surface of the accommodating body 20′. The portion cross-section in FIG. 3 illustrates the structure of the accommodating body 20′, which is a hollow casing.

The support base 2 or 2′ can also have a charging function so that the support base 2 or 2′ can be used as a charger. Therefore, the reference number 2 or 2′ can be also referred to a charger. In the present embodiment, the support base 2 or 2′ further comprises a charging contact portion 23, and when the hand-held electronic apparatus 1 is placed in the accommodating body 20 or 20′, the charging contact 12 of the hand-held electronic apparatus 1 contacts the charging contact portion 23 so as to charge the hand-held electronic apparatus 1 through the charging contact portion 23. Usually, the operation of charging requires a connection port 24 to connect to the power line 3, and the power line 3 is connected to a plug (not shown in the figures). However, since this technology is well known to those skilled in the art, no further details of this aspect of the present invention are provided here.

In summary, regardless of the function, way and result, the present invention is shown to have technical characteristics different from those of the prior art. However, the aforementioned embodiments are just for illustrating the principle and the result of the present invention and not for limiting the range of the present invention. It will be obvious to those skilled in the art that, based upon the descriptions herein, changes and modifications may be made without departing from this invention and its broader aspects. Therefore, the appended claims are intended to encompass within their scope all such changes and modifications as are within the true spirit and scope of the exemplary embodiments of the present invention.

What is claimed is:

1. A support base for placing a hand-held electronic apparatus therein, the hand-held electronic apparatus having a speaker, and the support base comprising:
an accommodating body, formed with a hollow casing, the shape of the accommodating body corresponding to a portion of the hand-held electronic apparatus such that the hand-held electronic apparatus can be placed therein, the accommodating body comprising a first sound broadcasting hole and a second sound broadcasting hole;
wherein, when the hand-held electronic apparatus is placed in the accommodating body, the speaker of the hand-held electronic apparatus is located corresponding to the first sound broadcasting hole, and the speaker of the hand-held electronic apparatus broadcasts sound through the first sound broadcasting hole and the second sound broadcasting hole.

2. The support base as claimed in claim 1, wherein the accommodating body comprises an accommodating surface and a plurality of non-accommodating surfaces; the accommodating surface is the surface contacting with the hand-held electronic apparatus, the first sound broadcasting hole is located in the accommodating surface, and the second sound broadcasting hole is located in any one of the non-accommodating surfaces.

3. The support base as claimed in claim 2, wherein the second sound broadcasting hole is located in an external surface of the accommodating body, and the external surface is the non-accommodating surface.

4. The support base as claimed in claim 1, wherein the first sound broadcasting hole is a plurality of holes or/and the second sound broadcasting hole is a plurality of holes.

5. The support base as claimed in claim 2, wherein the first sound broadcasting hole is a plurality of holes or/and the second sound broadcasting hole is a plurality of holes.

6. The support base as claimed in claim 3, wherein the first sound broadcasting hole is a plurality of holes or/and the second sound broadcasting hole is a plurality of holes.

7. The support base as claimed in claim 1, further comprising a charging contact portion, and the hand-held electronic apparatus has a charging contact; when the hand-held electronic apparatus is placed in the accommodating body, the charging contact of the hand-held electronic apparatus contacts the charging contact portion so as to charge the hand-held electronic apparatus through the charging contact portion.

8. A charger of a hand-held electronic apparatus, configured for placing and charging the hand-held electronic apparatus therein, the hand-held electronic apparatus having a speaker and a charging contact, the charger comprising:
an accommodating body, formed with a hollow casing, the shape of the accommodating body corresponding to a portion of the hand-held electronic apparatus such that the hand-held electronic apparatus can be placed therein, the accommodating body comprising a charging contact portion, a first sound broadcasting hole, and a second sound broadcasting hole;
wherein, when the hand-held electronic apparatus is placed in the accommodating body, the charging contact of the hand-held electronic apparatus contacts the charging contact portion so as to charge the hand-held electronic apparatus, the speaker of the hand-held electronic apparatus is located corresponding to the first sound broadcasting hole, and the speaker of the hand-held electronic apparatus broadcasts sound through the first sound broadcasting hole and the second sound broadcasting hole.

9. The charger as claimed in claim 8, wherein the accommodating body comprises an accommodating surface and a plurality of non-accommodating surfaces; the accommodating surface is the surface contacting the hand-held electronic apparatus, the first sound broadcasting hole is located in the accommodating surface, and the second sound broadcasting hole is located in any one of the non-accommodating surfaces.

10. The charger as claimed in claim 9, wherein the second sound broadcasting hole is located in an external surface of the accommodating body, and the external surface is a non-accommodating surface.

11. The charger as claimed in claim 8, wherein the first sound broadcasting hole is a plurality of holes or/and the second sound broadcasting hole is a plurality of holes.

12. The charger as claimed in claim 9, wherein the first sound broadcasting hole is a plurality of holes or/and the second sound broadcasting hole is a plurality of holes.

13. The charger as claimed in claim 10, wherein the first sound broadcasting hole is a plurality of holes or/and the second sound broadcasting hole is a plurality of holes.
